(19) United States
(12) Patent Application Publication
(10) Pub. No.: US 2013/0244003 A1
(43) Pub. Date: Sep. 19, 2013

(54) ORGANIC/INORGANIC HYBRID HIERARCHICAL STRUCTURE AND METHOD FOR MANUFACTURING SUPERHYDROPHOBIC OR SUPERHYDROPHILIC SURFACE USING SAME

(71) Applicants: Pil Jin Yoo, Seoul (KR); Young Hun Kim, Suwon-si (KR)

(72) Inventors: Pil Jin Yoo, Seoul (KR); Young Hun Kim, Suwon-si (KR)

(73) Assignee: Research & Business Foundation Sungkyunkwan University, Suwon-si (KR)

(21) Appl. No.: 13/989,630

(22) PCT Filed: Nov. 25, 2011
(86) PCT No.: PCT/KR11/09063

§ 371 Date: May 24, 2013

(30) Foreign Application Priority Data
Nov. 26, 2010 (KR) 10-2010-0118898

(51) Int. Cl. B32B 3/10

(52) U.S. Cl. CPC B32B 3/10
USPC 428/143; 428/141; 427/256; 427/534

(57) ABSTRACT

The present invention relates to an organic/inorganic hybrid hierarchical structure comprising: a polymer electrolyte layer which formed on a base and which has a rough surface; and an inorganic nano-structure formed on the rough surface of the polymer electrolyte layer. The present invention also relates to a method for manufacturing superhydrophobic or superhydrophilic surface using the organic/inorganic hybrid hierarchical structure.

### TECHNICAL FIELD

The present disclosure relates to an organic/inorganic hybrid hierarchical structure and a method for forming a superhydrophobic or superhydrophilic surface using the same.

### BACKGROUND ART

Generally, a contact angle is an angle formed by a liquid free surface and a solid flat surface at a point where the liquid is in contact with the solid, and it is determined by cohesion between liquid molecules and adhesion between the liquid and the solid. If the contact angle between the liquid and the solid flat surface is greater than 90°, the solid flat surface is considered hydrophobic, which means it has a low affinity with water. If the contact angle between the liquid and the solid flat surface is less than 90°, the solid flat surface is considered hydrophilic, which means it has a high affinity with water. Herein, if a contact angle between a certain material and a solid flat surface is greater than 150°, this is called superhydrophobic, which means it has a particularly low affinity with water. If a contact angle between a certain material and a solid flat surface is less than 10°, this is called superhydrophilic, which means it has a particularly high affinity with water.

Whether a material is hydrophobic or hydrophilic is determined by a surface roughness and a surface energy. According to the Wenzel's equation that explains wetting characteristics, a relationship between the contact angle and the surface roughness is defined as shown in the following Equation 1.

cos θ′=r cos θ [Equation 1]

Herein, r denotes the surface roughness, θ′ denotes the contact angle of a rough surface, and θ denotes a contact angle of a flat surface. Since the surface roughness r is greater than 1, if θ is smaller than 90° and the flat surface is hydrophilic, θ′ is smaller than θ and a hydrophilic property is enhanced, and if θ is greater than 90° and the flat surface is hydrophobic, θ′ is greater than θ and a hydrophobic property is enhanced. Therefore, a precondition for obtaining the hydrophobic property and the hydrophilic property is a high surface roughness. If a low surface energy is applied to a flat surface having a high surface roughness, the flat surface becomes superhydrophobic. If a high surface energy is applied to a flat surface having a high surface roughness, the flat surface becomes superhydrophilic.

Herein, a surface roughness is formed from a micro and nano structure of a surface. A method for forming a micro and nano structure includes mechanical machining, plasma etching, casting, and the like. A surface energy is increased or decreased by a chemical process such as plasma polymerization, wax solidification, anodic oxidation of metal, solution precipitation, chemical vapor deposition, addition of sublimation material, phase separation, and the like. Korean Registration of Patent No. 0891146 entitled “Fabrication method of superhydrophobic and superhydrophilic surfaces using hierarchical pore structure produced by electron beam irradiation” describes a method for producing a superhydrophilic or superhydrophobic material using a micro-nano composite pore structure having a high surface roughness by electron beam irradiation and a surface energy increasing/decreasing material.

However, in case of a mechanical method for forming a surface roughness, a small area can be formed through a single process, and if a large area is formed for industrial applications, a lot of time and costs are needed. In case of a chemical method for forming a surface energy, a large area can be formed through a single process but a complicated process employing manifold chemical materials needs to be performed. Further, it is highly possible that impurities are added during a transition from a process to another process. Therefore, a formed superhydrophobic or superhydrophilic surface may have a low uniformity.

### DISCLOSURE OF THE INVENTION

### Problems to Be Solved by the Invention

In view of the foregoing, the present disclosure provides a method for forming a large area organic/inorganic hybrid hierarchical structure through a simple process without using an additional device and a method for forming a superhydrophobic or superhydrophilic surface using the hierarchical structure which is easy to control in shape and/or characteristics.

However, problems to be solved by the present disclosure are not limited to the above-described problems. Although not described herein, other problems to be solved by the present disclosure can be clearly understood by those skilled in the art from the following description.

### Means for Solving the Problems

In accordance with an aspect of the present disclosure, there is provided an organic/inorganic hybrid hierarchical structure including a polymer electrolyte layer which is formed on a substrate and has a rough surface; and an inorganic nano structure which is formed at the rough surface of the polymer electrolyte layer.

In accordance with another aspect of the present disclosure, there is provided a method for forming a superhydrophobic or superhydrophilic surface, including forming a polymer electrolyte layer on a substrate; forming an inorganic nanoparticle at the polymer electrolyte layer to form a polymer electrolyte/inorganic nanoparticle composite layer having a surface roughness; and removing the polymer electrolyte layer from the composite layer and forming an inorganic nano structure along the surface roughness to form an organic/inorganic hybrid hierarchical structure.

In accordance with still another aspect of the present disclosure, there is provided a superhydrophobic or superhydrophilic surface formed by using an organic/inorganic hybrid hierarchical structure by the method.

### Effect of the Invention

In accordance with the present disclosure, it is possible to provide a method for forming a large-area organic/inorganic hybrid hierarchical structure through a simple process without using an additional device and a method for forming a superhydrophobic or superhydrophilic surface using the hierarchical structure which is easy to control in shape and/or characteristics. In accordance with the present disclosure, there is no need to use an expensive processing device or a pattern mould, etc., and, thus, it is possible to form a large-area, high-quality superhydrophobic or superhydrophilic surface through a simple and economical wet process. Further, in accordance with the present disclosure, a polymer electrolyte layer or an inorganic nano structure may have various sizes, and, thus, it is possible to easily adjust a shape and/or characteristics of a superhydrophobic or superhydrophilic surface.

Furthermore, in accordance with the present disclosure, a polymer electrolyte multilayered film capable of being deposited on various substrate is used, and, thus, it is possible to form a superhydrophobic or superhydrophilic surface regardless of a kind of a substrate.

### BRIEF DESCRIPTION OF THE DRAWINGS

FIG. 1 is a flow chart for explaining a method for forming a superhydrophobic or superhydrophilic surface in accordance with an illustrative embodiment of the present disclosure.

FIG. 2 is a process diagram for explaining the method for forming a superhydrophobic or superhydrophilic surface in accordance with an illustrative embodiment of the present disclosure.

FIG. 3 provides atomic force microscopic images showing a surface of a composite layer in accordance with an example of the present disclosure.

FIG. 4 provides atomic force microscopic images identified through FFT (Fast Fourier Transform) and illustrating that a wavelength can be adjusted depending on a thickness of a polymer electrolyte layer in accordance with an example of the present disclosure.

FIG. 5 provides images obtained from observation of an amplitude of a surface roughness depending on the number of processes for forming an inorganic nanoparticle in accordance with an example of the present disclosure.

FIG. 6 provides photos obtained from observation of a cross section of a composite layer depending on a degree of reduction of an inorganic nanoparticle in accordance with an example of the present disclosure.

FIG. 7 provides scanning electron microscopic images showing a surface of an organic/inorganic hybrid hierarchical structure in accordance with an example of the present disclosure.

FIG. 8 provides scanning electron microscopic images showing a cross section of an organic/inorganic hybrid hierarchical structure in accordance with an example of the present disclosure.

FIG. 9 provides photos showing a water contact angle of a surface of an organic/inorganic hybrid hierarchical structure in accordance with an example of the present disclosure.

FIG. 10 provides photos obtained from observation of water drops formed on a surface of an organic/inorganic hybrid hierarchical structure in accordance with an example of the present disclosure.

FIG. 11 provides a result of observation for a change in a water contact angle depending on a time of plasma asking process used to remove the polymer layer from a composite when an organic/inorganic hybrid hierarchical structure is formed in accordance with an example of the present disclosure.

FIG. 12 provides a image showing formation of a large-area superhydrophobic surface (5 cm×15 cm) of an organic/inorganic hybrid hierarchical structure in accordance with an example of the present disclosure.

### BEST MODE FOR CARRYING OUT THE INVENTION

Hereinafter, illustrative embodiments and examples of the present disclosure will be described in detail with reference to the accompanying drawings so that the present disclosure may be readily implemented by those skilled in the art.

However, it is to be noted that the present disclosure is not limited to the illustrative embodiments and examples but can be embodied in various other ways. In drawings, parts irrelevant to the description are omitted for the simplicity of explanation, and like reference numerals denote like parts through the whole document.

Further, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “step of” does not mean “step for”.

Through the whole document, the term “on” that is used to designate a position of one element with respect to another element includes both a case that the one element is adjacent to the another element and a case that any other element exists between these two elements. Further, the term “comprises or includes” and/or “comprising or including” used in the document means that one or more other components, steps, operation and/or existence or addition of elements are not excluded in addition to the described components, steps, operation and/or elements unless context dictates otherwise.

The term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party.

In accordance with an aspect of the present disclosure, there is provided an organic/inorganic hybrid hierarchical structure including a polymer electrolyte layer which is formed on a substrate and has a rough surface; and an inorganic nano structure which is formed at the rough surface of the polymer electrolyte layer.

In an illustrative embodiment, a surface energy increasing/decreasing material may be further included on the inorganic nano structure and a surface of inorganic nano structure to provide a superhydrophobic or superhydrophilic property, but the present disclosure may not be limited thereto.

In an illustrative embodiment, the rough surface may have a shape of, but may not be limited thereto, a wrinkled pattern. By way of example, the wrinkled pattern may have various regular or irregular shaped-patterns. In an illustrative embodiment, a size of a roughness of the rough surface may be in micrometric units, for example, but may not be limited thereto, from about 1 μm to about 1,000 μm, or from about 1 μm to about 500 μm, or from about 1 μm to about 100 μm, or from about 1 μm to about 50 μm.

In an illustrative embodiment, the inorganic nano structure may have, but may not be limited thereto, nanopores. In an illustrative embodiment, since the organic/inorganic hybrid hierarchical structure includes the inorganic nano structure formed on a surface roughness having the surface roughness in micrometers, and, thus, the organic/inorganic hybrid hierarchical structure may have a micro-nano composite structure, but the present disclosure may not be limited thereto.

In an illustrative embodiment, a shape of the inorganic nano structure may be selected from, but may not be limited thereto, the group consisting of a nanoparticle, a nanoplate, a nanorod, a nanoneedle, a nanotube, and a nanowall. In an illustrative embodiment, a size of the inorganic nano structure may be, but may not be limited thereto, from about 10 nm to about 1,000 nm, or from about 10 nm to about 500 nm, or from about 10 nm to about 300 nm, or from about 10 nm to about 100 nm.

In the present disclosure the substrate does not specifically limit, it may be possible to use a substrate made of a certain kind of a material for making a superhydrophobic or superhydrophilic surface property. By way of example, various materials such as polymer, glass, metal, semiconductor, and so on, may be used for the substrate.

In an illustrative embodiment, the substrate may include, but may not be limited thereto, a substrate which is surface-treated to have a negative charge or a positive charge in order to make it easy to form the polymer electrolyte layer on the substrate. Further, the substrate may include a substrate which is not surface-treated. In this case, the polymer electrolyte layer on the substrate may include, but may not be limited thereto, being formed by physical adsorption.

In an illustrative embodiment, the polymer electrolyte layer having the surface roughness may include, but may not be limited thereto, a polymer electrolyte layer having a surface roughness increased by forming an inorganic nanoparticle within a predetermined depth from the surface of the polymer electrolyte layer. By way of example, the inorganic nanoparticle may be formed within the surface of the polymer electrolyte layer at a depth from the surface so as to correspond to, but may not be limited thereto, from about ⅓ to about ½ of the total thickness of the polymer electrolyte layer.

In an illustrative embodiment, the inorganic nano structure may be protruded from the rough surface of the polymer electrolyte layer, but the present disclosure may not be limited thereto.

In an illustrative embodiment, the inorganic nano structure may include, but may not be limited thereto, a metal or a semiconductor. By way of example, if the inorganic nanoparticle is the metal, the inorganic nanoparticle may include a metal selected from, but may not be limited thereto, the group consisting of gold, silver, palladium, lead sulfide, and combinations thereof.

In an illustrative embodiment, the polymer electrolyte layer may include, but may not be limited thereto, a cationic polymer electrolyte layer and an anionic polymer electrolyte layer formed alternately. In an illustrative embodiment, the polymer electrolyte layer may include, but may not be limited thereto, multiple layers of the cationic polymer electrolyte layer and the anionic polymer electrolyte layer formed alternately. In another illustrative embodiment, a polymer electrolyte known in the art may be used to form the polymer electrolyte layer particularly without limitations. By way of example, a polymer electrolyte having an anionic or cationic functional group may be used. Further, the anionic or cationic functional group is not especially limited. By way of example, an anionic polymer electrolyte having a carboxylic group as the anionic functional group may be used. The anionic polymer electrolyte may include, but may not be limited thereto, a polymer such as polycarboxylic acid, polysulfonic acid, etc., or a bio-polymer such as poly hyaluronic acid, etc. By way of example, the anionic polymer electrolyte having a carboxylic group as the anionic functional group may be used, and a cationic polymer electrolyte may include, but may not be limited thereto, a polymer such as polyamine, etc., or a bio-polymer such as polylysine, etc.

In accordance with another illustrative embodiment of the present disclosure, there is provided a method for forming a superhydrophobic or superhydrophilic surface including forming a polymer electrolyte layer on a substrate; forming an inorganic nanoparticle at the polymer electrolyte layer to form a polymer electrolyte/inorganic nanoparticle composite layer having a surface roughness; and removing the polymer electrolyte layer from the composite layer and forming an inorganic nano structure along the surface roughness to form an organic/inorganic hybrid hierarchical structure.

In an illustrative embodiment, the method for forming a superhydrophobic or superhydrophilic surface may further include, but may not be limited thereto, forming a surface energy increasing/decreasing material layer on the hierarchical structure for making the superhydrophobic or superhydrophilic property. In an illustrative embodiment, the surface energy increasing/decreasing material layer may include a self-assembly monomolecular layer formed by using a material containing a fluorine group and a hydrophilic or hydrophobic end group.

In an illustrative embodiment, the polymer electrolyte layer may include an ionic functional group at its polymer chain, and the inorganic nanoparticle may be formed by using an ionic inorganic precursor, but the present disclosure may not be limited thereto. In an illustrative embodiment, the inorganic nanoparticle may be formed within the polymer electrolyte layer by, but may not be limited thereto, diffusion through an ion-exchange reaction between an anionic functional group contained in the polymer electrolyte and an inorganic cation contained in the inorganic precursor by implanting a solution containing the inorganic precursor from the surface of the polymer electrolyte layer. In another illustrative embodiment, the inorganic nanoparticle may be further included by, but may not be limited thereto, implanting a reducing agent after the solution containing the inorganic precursor is implanted. By way of example, the inorganic nanoparticle may be formed by process, including, but may not be limited thereto, implanting an inorganic cation into the polymer electrolyte layer by means of diffusion through an ion-exchange reaction between an ionic functional group contained in the polymer electrolyte and the inorganic cation contained in the ionic inorganic precursor by implanting the ionic inorganic precursor from the surface of the polymer electrolyte layer, and forming the inorganic nanoparticle by implanting a reducing agent from the surface of the polymer electrolyte layer to reduce the inorganic cation implanted into the polymer electrolyte layer.

In an illustrative embodiment, the inorganic nanoparticle may be formed within the polymer electrolyte layer at a predetermined depth from the surface of the polymer electrolyte layer to form the composite layer. As an amount of the formed inorganic nanoparticle increases, the surface roughness of the composite layer increases, but the present disclosure may not be limited thereto.

In an illustrative embodiment, an amount and/or thickness of the inorganic nanoparticle may be adjusted by performing the process for forming the inorganic nanoparticle once or more to adjust the surface roughness of the composite layer, but the present disclosure may not be limited thereto.

In an illustrative embodiment, the polymer electrolyte layer may include, but may not be limited thereto, a cationic polymer electrolyte layer and an anionic polymer electrolyte layer formed alternately.

In an illustrative embodiment, the polymer electrolyte layer may include, but may not be limited thereto, multiple layers of the cationic polymer electrolyte layer and the anionic polymer electrolyte layer formed alternately. By way of example, an uppermost layer of the polymer electrolyte layer may be formed of the anionic polymer electrolyte layer. Thus, the inorganic cation in the implanted inorganic nanoparticle precursor containing solution can be easily implanted into the polymer electrolyte layer by means of diffusion through an ion-exchange reaction between the inorganic cation contained in the implanted solution containing the inorganic nanoparticle precursor and the anionic functional group of the uppermost anionic polymer electrolyte layer.

In another illustrative embodiment, the polymer electrolyte layer may be cross-linked so as to stably synthesize the inorganic nanoparticle, but the present disclosure may not be limited thereto. The cross-linking of the polymer electrolyte layer may be performed by using a cross-linking agent known in the art. The cross-linking agent may be selected by those skilled in the art depending on a kind of a polymer electrolyte to be used.

A polymer electrolyte known in the art may be used to form the polymer electrolyte layer particularly without limitations. By way of example, a polymer electrolyte having an anionic or cationic functional group may be used. Further, the anionic or cationic functional group is not especially limited. By way of example, an anionic polymer electrolyte having a carboxylic group as the anionic functional group may be used. The anionic polymer electrolyte may include, but may not be limited thereto, a polymer such as polycarboxylic acid, polysulfonic acid, etc., or a bio-polymer such as poly hyaluronic acid, etc. By way of example, the anionic polymer electrolyte having a carboxylic group as the anionic functional group may be used, and a cationic polymer electrolyte may include, but may not be limited thereto, a polymer such as polyamine, etc., or a bio-polymer such as polylysine, etc.

In an illustrative embodiment, the forming of the organic/inorganic hybrid hierarchical structure may include, but may not be limited thereto, selectively removing the polymer electrolyte by using the inorganic nanoparticle contained in the polymer electrolyte/inorganic nanoparticle composite layer having the surface roughness as a mask to form the inorganic nano structure along the surface roughness.

In an illustrative embodiment, the removing the polymer electrolyte from the composite layer may be performed by, but may not be limited thereto, reactive ion etching (RIE) or plasma asking.

In an illustrative embodiment, the surface roughness may be formed, but may not be limited thereto, in micrometers.

In an illustrative embodiment, the inorganic nano structure may have, but may not be limited thereto, nanopores. In an illustrative embodiment, since the organic/inorganic hybrid hierarchical structure includes the inorganic nano structure formed along the surface roughness in micrometric size, the organic/inorganic hybrid hierarchical structure has a micro-nano composite structure, but the present disclosure may not be limited thereto.

In an illustrative embodiment, a shape of the inorganic nano structure may be selected from, but may not be limited thereto, the group consisting of a nanoparticle, a nanoplate, a nanorod, a nanoneedle, a nanotube, and a nanowall. In an illustrative embodiment, a size of the inorganic nano structure may be, but may not be limited thereto, from about 10 nm to about 1,000 nm, or from about 10 nm to about 500 nm, or from about 10 nm to about 300 nm, or from about 10 nm to about 100 nm.

The method for forming the superhydrophobic or superhydrophilic surface may include all descriptions about the organic/inorganic hybrid hierarchical structure, and redundant descriptions will be omitted for the sake of convenience.

In accordance with still another illustrative embodiment, there is provided a superhydrophobic or superhydrophilic surface formed by using an organic/inorganic hybrid hierarchical structure according to the above-described method. The superhydrophobic or superhydrophilic surface may include all descriptions about the organic/inorganic hybrid hierarchical structure and the method for forming the superhydrophobic or superhydrophilic surface, and redundant descriptions will be omitted for the sake of convenience.

Hereinafter, the superhydrophobic or superhydrophilic surface and a method for forming the same in accordance with the present disclosure will be explained in detail with reference to the accompanying drawings. However, the present disclosure may not be limited thereto.

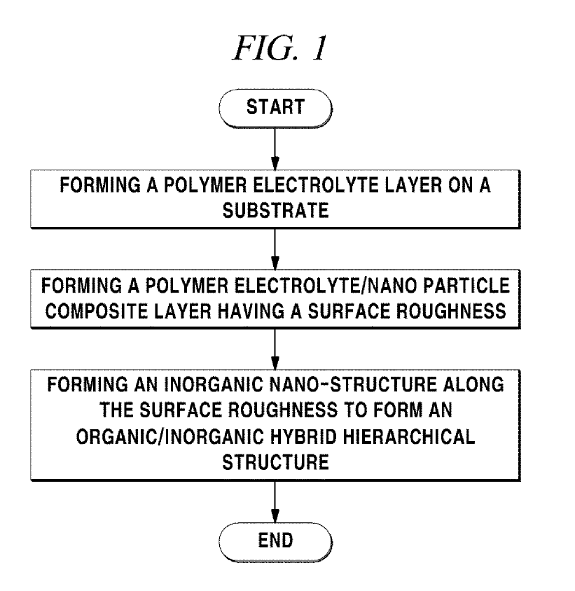

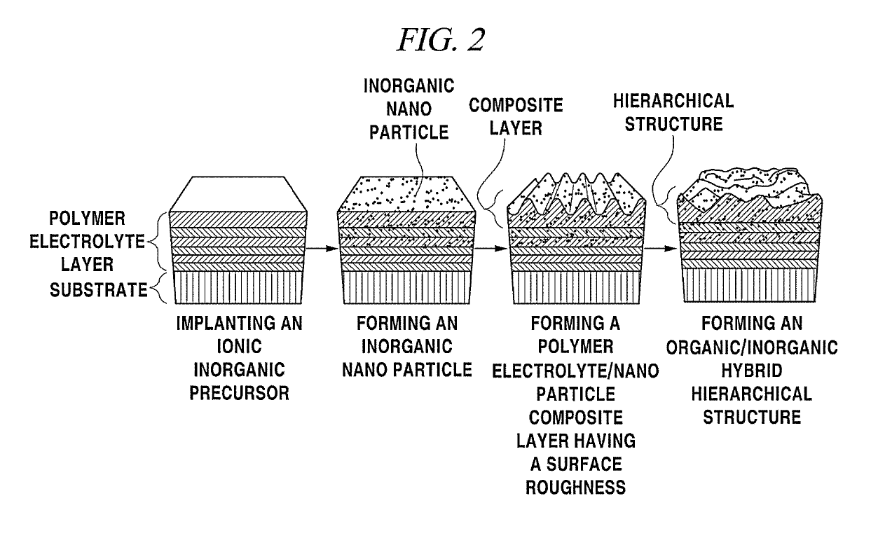

FIGS. 1 and 2 provide a flow chart and a process diagram, respectively, for explaining a method for manufacturing a superhydrophobic or superhydrophilic surface by using an organic/inorganic hybrid hierarchical structure. To be specific, in accordance with an illustrative embodiment of the present disclosure, a method for forming a superhydrophobic or superhydrophilic surface may include forming a polymer electrolyte layer on a substrate; forming an inorganic nanoparticle at the polymer electrolyte layer to form a polymer electrolyte/inorganic nanoparticle composite layer having a surface roughness; removing the polymer electrolyte layer from the composite layer and forming an inorganic nano structure along the surface roughness to form an organic/inorganic hybrid hierarchical structure; and making a surface of the hierarchical structure superhydrophobic or superhydrophilic with selective formation of a surface energy increasing/decreasing material layer on the hierarchical structure, but may not be limited thereto.

First, the polymer electrolyte layer is formed on the substrate. The substrate may be employed from those used in the art without limitations if a polymer electrolyte layer can be easily formed thereon. By way of example, the substrate does not specifically limit the present disclosure, and it may be possible to use without limitations, a substrate made of a certain kind of a material for making the surface superhydrophobic or superhydrophilic. By way of example, the substrate may use various materials such as polymer, glass, metal, and semiconductor. In an illustrative embodiment, the substrate may be, but may not be limited thereto, indium tin oxide substrate. Further, the substrate may include, but may not be limited thereto, a substrate which is surface-treated in order to make it easy to form the polymer electrolyte layer on the substrate. By way of example, if the polymer electrolyte layer to be deposited is made of the cationic polymer electrolyte, a surface of the substrate may be surface-treated to have a negative charge. If the polymer electrolyte layer to be deposited is made of the anionic polymer electrolyte, a surface of the substrate may be surface-treated to have a positive charge.

The polymer electrolyte layer includes polymer electrolyte layers in various shapes. The polymer electrolyte layer may be formed of, for example, a single layer or multiple layers and may be formed by alternately depositing a cationic polymer electrolyte layer and an anionic polymer electrolyte layer. If the polymer electrolyte layer is formed of multiple layers, desirably, an uppermost layer of the multilayered polymer electrolyte layer may be an anionic polymer electrolyte layer. By way of example, if the polymer electrolyte layer is the anionic polymer electrolyte layer, the ion-exchange reaction between an anionic functional group within the polymer electrolyte layer and an inorganic cation of the inorganic precursor can be easily conducted. Thus, it is possible to easily implant the inorganic cation from the surface to an inner part of the polymer electrolyte layer.

Then, the inorganic nanoparticle is formed within the polymer electrolyte layer and a polymer electrolyte/inorganic nanoparticle composite layer having a surface roughness is formed. In an illustrative embodiment to form the composite layer, an ionic inorganic precursor solution is implanted to the inner part of the polymer electrolyte layer, and the composite layer having a surface roughness may be formed at the same time as the inorganic nanoparticle is formed from the ionic inorganic precursor solution.

To be more specific, in an illustrative embodiment, if the substrate on which the polymer electrolyte layer is formed is immersed in the ionic inorganic precursor solution, an inorganic cation in the ionic inorganic precursor solution can be absorptively implanted to the inner part of the polymer electrolyte layer by means of diffusion through an ion-exchange reaction between the inorganic cation (for example, metal cation) in the ionic inorganic precursor solution and an anionic functional group at a polymer chain to form the polymer electrolyte layer. Desirably, the ionic inorganic precursor solution formed by the above-described method may be formed within the polymer electrolyte layer at a predetermined depth from the surface of the polymer electrolyte layer. Thereafter, a reducing agent may be further implanted from the surface of the polymer electrolyte layer to reduce the inorganic cation implanted into the polymer electrolyte layer and the inorganic nanoparticle is formed. Thus, the polymer electrolyte/inorganic nanoparticle composite layer can be formed. In an illustrative embodiment, the composite layer may be formed to some inner part of one side surface of the polymer electrolyte layer formed on the substrate, and specifically, within the polymer electrolyte layer at a certain depth from the surface of the polymer electrolyte layer.

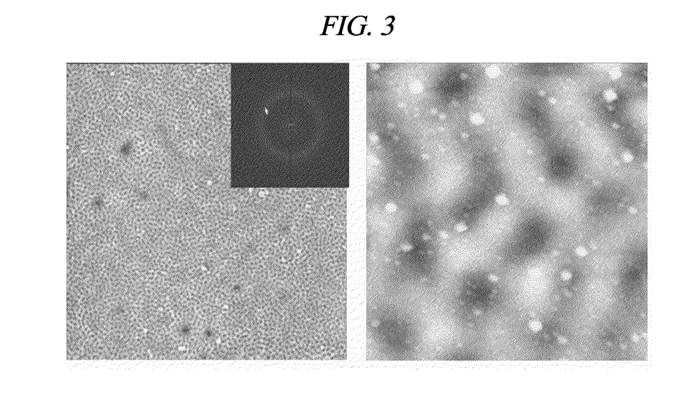

If a stress generated while the ionic inorganic precursor solution is converted into the inorganic nanoparticle exceeds a critical point which the polymer electrolyte layer can withstand, the polymer electrolyte layer releases the stress by a wrinkled phenomenon. Thus, the composite layer including the polymer electrolyte and the inorganic nanoparticle may have a surface roughness of, for example, a wave-shaped wrinkled pattern. Further, a size of the wave-shaped wrinkled pattern may include having a size in several hundred nanometers to several hundred micrometers. FIG. 3 provides photos obtained from observation of inorganic nanoparticles in several nanometers to several ten nanometers formed on a surface forming a wrinkled pattern having a size in micrometers and formed in accordance with the above-described method.

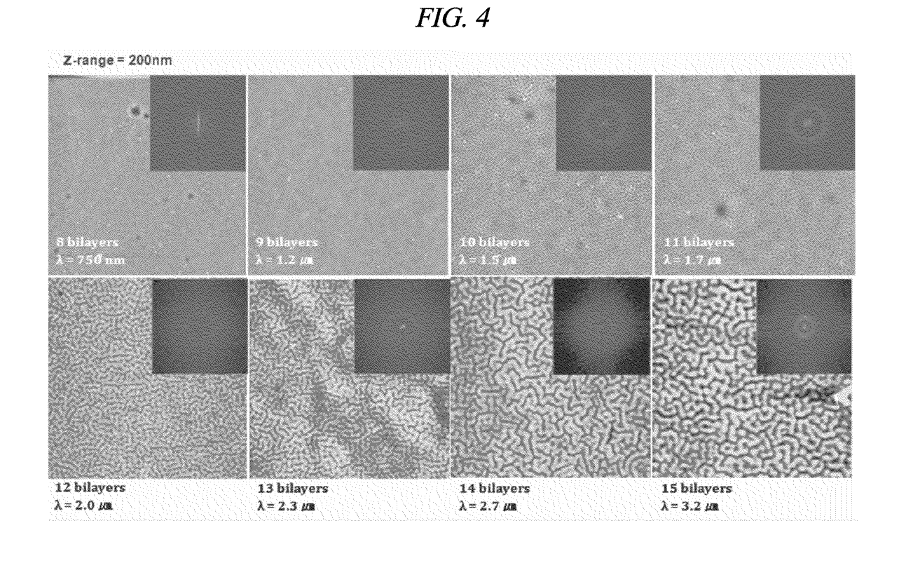

By adjusting a thickness of the polymer electrolyte layer, it is possible to easily adjust a depth at which the inorganic nanoparticle is formed and/or the surface roughness. By way of example, if the surface roughness is formed of a wrinkled pattern, a wrinkled gap and/or a wrinkled thickness of the wrinkled pattern can be adjusted depending on the thickness of the polymer electrolyte layer. It can be seen from FIG. 4 that as the thickness of the polymer electrolyte layer increases, the wrinkled gap and the wrinkled thickness of the formed wrinkled pattern increase.

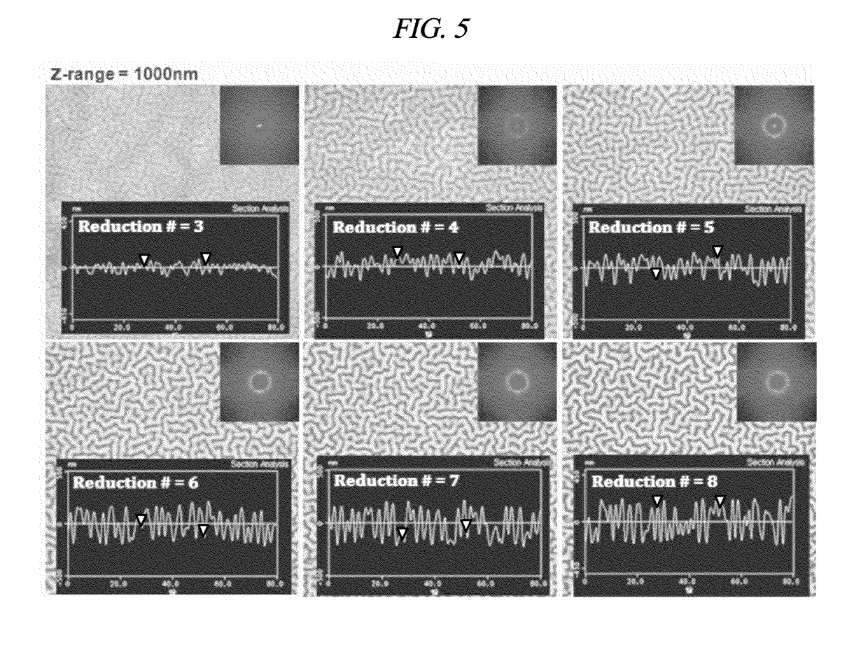

If necessary, in order to form the polymer electrolyte/inorganic nanoparticle composite layer having the surface roughness, the process for forming the inorganic nanoparticle from the inorganic precursor layer may be repeated multiple times. FIG. 5 provides photos obtained from observation of the width of the wrinkled pattern formed after a degree of reduction of the ionic inorganic precursor solution is varied to form the inorganic nanoparticle. As the degree of reduction increases, the amount of the inorganic nanoparticle increases. As a storage stress within a surface layer increases, a structure having a high roughness is formed.

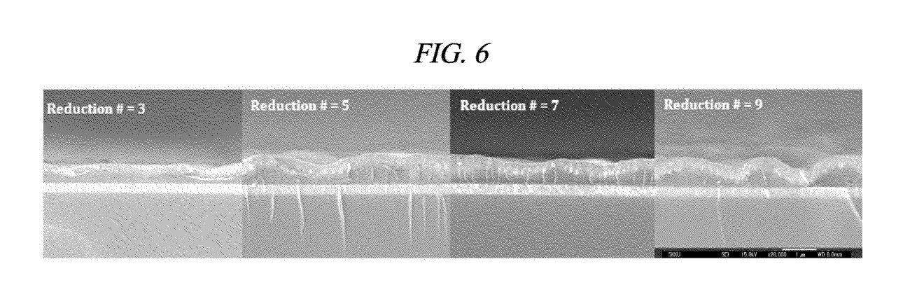

Further, a size of the inorganic nanoparticle is adjusted by adjusting a condition for synthesis of the inorganic nanoparticle, so that a size and/or a shape of the surface roughness can be adjusted. Thus, it is possible to control a water contact angle of a surface of the organic/inorganic hybrid hierarchical structure formed by removing the polymer electrolyte through an etching process. In an illustrative embodiment for adjusting the condition for synthesis of the inorganic nanoparticle, the water contact angle can be adjusted by adjusting a reduction rate of the inorganic nanoparticle. By way of example, if a reduction rate is high to form the inorganic nanoparticle, a large amount of a small-sized inorganic nanoparticle can be formed in a short time, and if a reduction rate is low, a large-sized inorganic nanoparticle can be formed slowly. Therefore, the water contact angle can be increased in case of the small-sized particle rather than the large-sized particle. Referring to FIG. 6, it can be seen that as the degree of reduction increases to form the inorganic nanoparticle from the ionic inorganic precursor, a thickness of the polymer electrolyte/nanoparticle composite layer (bright-colored area in FIG. 6) increases.

Although there has been described about the wrinkle pattern as a shape of the surface roughness, the shape of the surface roughness of the composite may have various others shapes of the rough surface. The surface roughness may have various regular or irregular shaped-patterns, but the present disclosure may not be limited thereto.

As described above, in accordance with the present disclosure, in order to form a pattern in micrometric units which can improve the surface roughness of the polymer electrolyte layer, a structure having the surface roughness in micrometric units can be easily formed by a simple wet process unlike a conventional process including coating, baking, exposure, development, washing, drying, etching, and so on, using a photoresist and a photolithography process requiring a lithography device. Further, in the forming method of the present disclosure, a specific mould used for a top-down manufacturing method is not needed, and, thus, materials harmful to humans or the environment may not be used. That is, the method for forming a superhydrophobic or superhydrophilic surface of the present disclosure does not require a lithography device or an expensive processing device such as a pattern mould, and, thus, a cost for increasing a surface roughness of the polymer electrolyte layer can be reduced and an economic feasibility of the process can be obtained.

Then, the polymer electrolyte is removed from the composite layer, so that an inorganic nano structure is formed along the surface roughness so as to form the organic/inorganic hybrid hierarchical structure. The hierarchical structure described in the present disclosure may include, but may not be limited thereto, a structure including a nano-sized porous structure on the composite by removing the polymer electrolyte from the polymer electrolyte/inorganic nanoparticle composite layer having the surface roughness in micrometers. The removing the polymer electrolyte includes removing all or a part of the polymer electrolyte from the composite.

As the method for removing the polymer electrolyte, an etching method typically used in the art can be used without limitations. By way of example, the method may include reactive ion etching or plasma asking, etc. By etching, the inner part of the composite except a part where the inorganic nanoparticle is formed is selectively etched, so that the inorganic nano structure is formed. In this case, the inorganic nanoparticle formed within the composite acts as a kind of a mask, and due to a masking effect, the inorganic nano structure can be easily formed on the polymer electrolyte layer having the surface roughness.

The inorganic nanoparticle may be one or multiple nanoparticles. If the inorganic nanoparticle is multiple, a kind of an inorganic nano structure shape including multiple inorganic nanoparticles may be formed and may have various shapes such as a nanoparticle, a nanoplate, a nanorod, a nanoneedle, a nanotube, a nanowall, and so on.

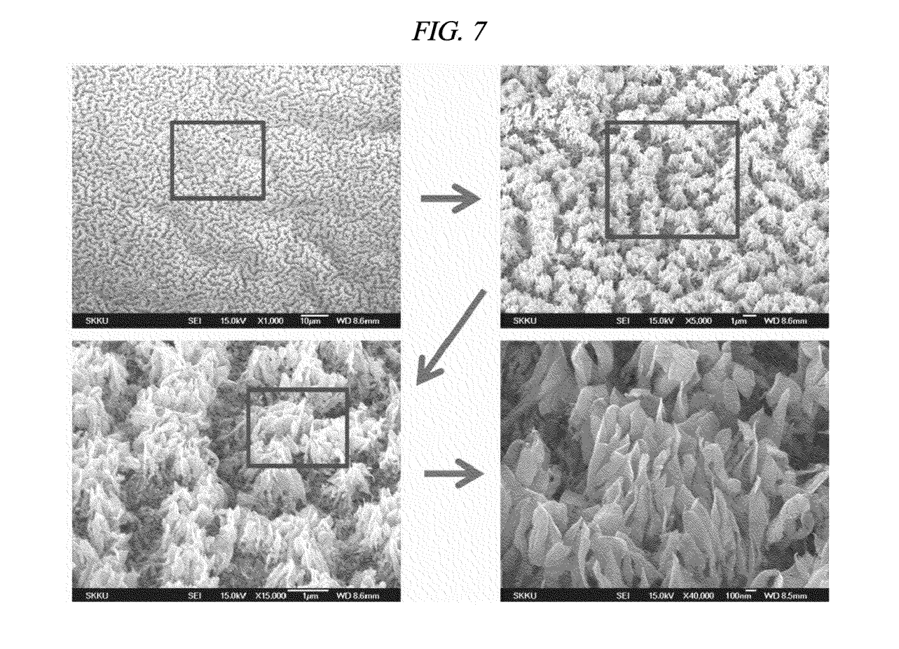

FIG. 7 provides photos with various magnifications obtained from observation of a surface of the hierarchical structure formed by removing the polymer electrolyte from the composite layer with plasma cleaner. Referring to FIG. 7, it can be seen that the inorganic nano structure is formed on an irregular wrinkled pattern on the surface of the hierarchical structure.

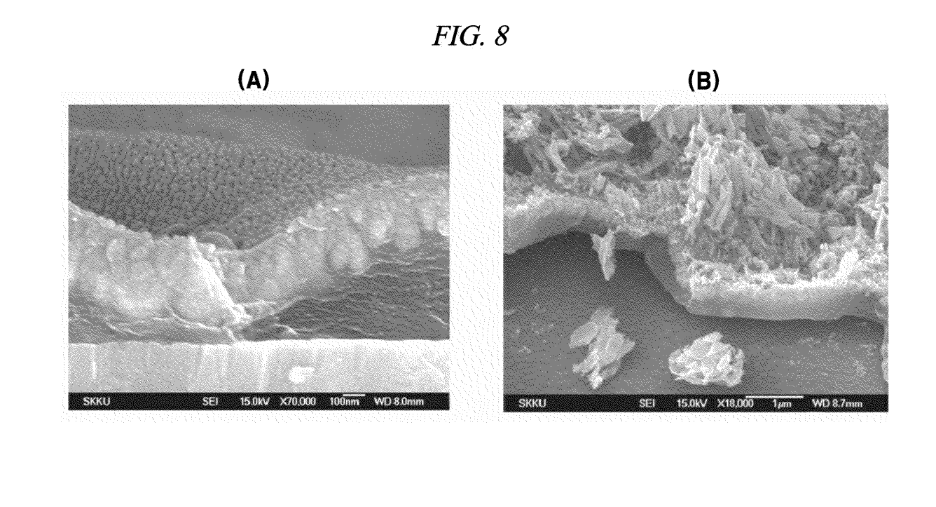

FIG. 8 provides photos obtained after observation of a cross section of the hierarchical structure in accordance with another example of the present disclosure. To be more specific, FIG. 8a provides the photo obtained from observation of the cross section of the composite layer and FIG. 8b provides the photo obtained after observation of the cross section of the hierarchical structure in which the polymer electrolyte layer is removed from the composite layer.

Further, the surface energy increasing/decreasing) material layer may be formed on the hierarchical structure so that it is possible to make the surface superhydrophobic and superhydrophilic. If a low surface energy material is added to the surface of the hierarchical structure, the surface becomes superhydrophobic, and if a high surface energy material is added to the surface having a high surface roughness, the surface becomes superhydrophilic. By way of example, a surface energy decreasing material may include a compound selected from, but may not be limited thereto, the group consisting of a fluorine group-containing silane-based compound, a fluorine group-containing thiol-based compound, a fluorine group-containing chloride-based compound, and combinations thereof. The surface energy increasing/decreasing material layer may be, but may not be limited thereto, a self-assembly monomolecular layer formed by using a material containing a fluorine group and a hydrophilic or hydrophobic end group.

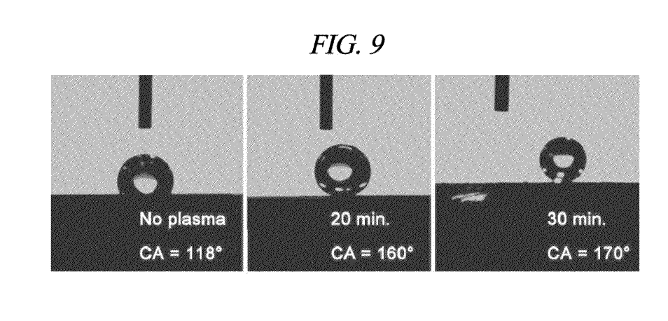

FIG. 9 provides photos showing a water contact angle of the surface of the organic/inorganic hybrid hierarchical structure under various plasma process times. To be more specific, the photos are obtained from observation of a water contact angle when after the organic/inorganic hybrid hierarchical structure is formed under various plasma processing times, a self-assembly monomolecular layer containing fluorine is formed on the surface of the hierarchical structure. A surface without the plasma process has the water contact angle of 118°, a surface under a plasma processing time of 20 minutes has the water contact angle of 160°, and a surface under a plasma processing time of 30 minutes has the water contact angle of 170°. Thus, as the plasma processing time increases, the water contact angle increases.

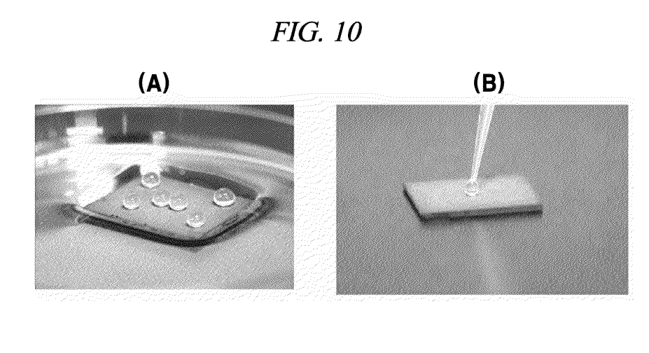

Referring to FIG. 10, it can be observed that water drops are formed on a superhydrophobic surface formed by the forming method of the present disclosure, and it can be seen that the surface is very superhydrophobic.

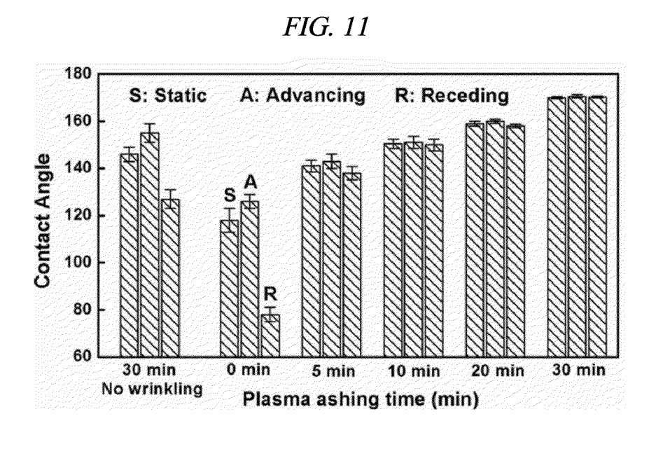

FIG. 11 shows a change in a water contact angle depending on the plasma asking processing time. It can be seen that as a processing time increases, a superhydrophobic property is enhanced. By way of example, when the processing time is 30 minutes or more, the water contact angle is 170° or more.

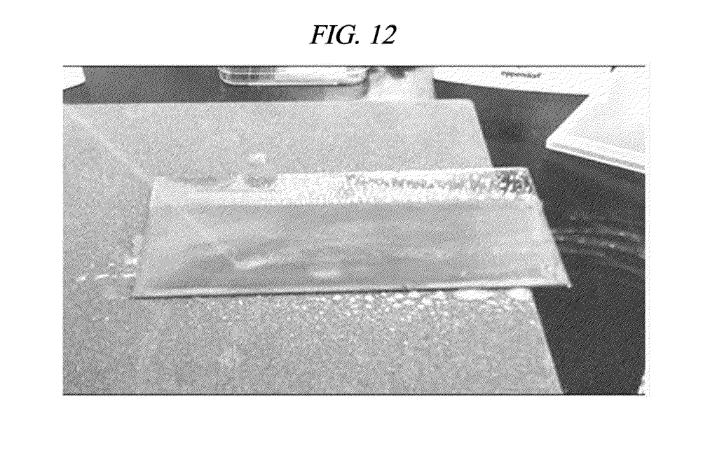

FIG. 12 shows that if the process of the present disclosure is performed on a superhydrophobic surface formed on a large-area surface of 5 cm×15 cm, it is possible to easily form the large-area superhydrophobic surface.

Hereinafter, the present disclosure will be explained in more detail with reference to an example, but the present disclosure is not limited thereto.

### EXAMPLE 1

An indium tin oxide (ITO) substrate was deposited by a sputtering method and has a rough surface. The ITO substrate was processed with plasma cleaner for 30 seconds to generate a negative charge on the surface thereof. Then, in a slide strainer where a wet coating process can be programmed, a process including immersing the ITO substrate in a cationic polymer electrolyte bath for 8 minutes and washing the ITO substrate in a DI water bath for 1 minute was repeated three times. Thereafter, a process including immersing the ITO substrate in an anionic polymer electrolyte bath for 8 minutes and washing the ITO substrate in the DI water bath was repeated several times, so that a polymer electrolyte multilayered film having a desired thickness was deposited. The process was performed after linear polyethylenimine of 35 mM and poly acrylic acid of 20 mM were prepared as the cationic polymer electrolyte and the anionic polymer electrolyte, respectively, with a pH of 4.8 similar to a pKa value suitable for maintaining a high diffusibility.

After the polymer electrolyte multilayered film having a desired thickness was deposited, the polymer electrolyte multilayered film formed on the ITO substrate was immersed in 1-Ethyl-3-(3-dimethylaminopropyl) carbodiimide (EDC) of 5 mM for 10 hours and the polymer electrolyte multilayered film was cross-linked in order to stably synthesize an inorganic nanoparticle.

To be more specific, in order to synthesize a silver nanoparticle within the polymer electrolyte multilayered film, the polymer electrolyte multilayered film deposited on the ITO substrate was immersed in a silver acetate aqueous solution of 5 mM for 8 minutes and washed with DI water. Then, it was immersed in DMAB (dimethylamine borane) of 2 mM as a reducing agent for 8 minutes, so that the silver nanoparticle were synthesized through an ion-exchange reaction between a carboxylic acid group within the polymer electrolyte multilayered film and a silver ion. This process was repeated from several times to several ten times until a hierarchical structure was formed.

A reactive ion etching (RIE) process was performed on a surface on which a wrinkled phenomenon of a hierarchical structure was formed in from several ten micrometers to several hundred nanometers by the above-described process to remove a polymer layer. Thus, a pore structure of a size in several ten nanometers was formed, and the surface had wrinkles in both micrometers and nanometers. Thereafter, the surface was immersed in tridecafluoro-1-octanethiol for 8 hours, and, thus, a fluoro functional group was supplied to the surface. It was found that the surface became a superhydrophobic surface having a water contact angle of 170°.

To be specific, FIG. 7 provides photos with various magnifications obtained from observation of a surface of the hierarchical structure formed by removing the polymer electrolyte from the composite layer with plasma cleaner in accordance with the present example. Referring to FIG. 7, it can be seen that an inorganic nano structure is formed on an irregular wrinkled pattern on the surface of the hierarchical structure.

FIG. 8 provides photos obtained after observation of a cross section of the hierarchical structure in accordance with the present example. To be more specific, FIG. 8a provides the photo obtained from observation of the cross section of the composite layer and FIG. 8b provides the photo obtained after observation of the cross section of the hierarchical structure in which the polymer electrolyte layer is removed from the composite layer.

FIG. 9 provides photos showing a water contact angle of the surface of the organic/inorganic hybrid hierarchical structure under various plasma process times in accordance with the present example. To be more specific, the photos are obtained from observation of a water contact angle when after the organic/inorganic hybrid hierarchical structure is formed under various plasma processing times, a self-assembly monomolecular layer containing fluorine is formed on the surface of the hierarchical structure. A surface without a plasma process has the water contact angle of 118°, a surface under the plasma processing time of 20 minutes has the water contact angle of 160°, and a surface under the plasma processing time of 30 minutes has the water contact angle of 170°. Thus, as the plasma processing time increases, the water contact angle increases.

Referring to FIG. 10, it can be observed that water drops are formed on the superhydrophobic surface formed in accordance with the present example, and it can be seen that the surface is very superhydrophobic.

FIG. 11 shows a change in a water contact angle depending on a plasma asking processing time in accordance with the present example. It can be seen that as the processing time increases, the superhydrophobic property is enhanced. By way of example, when the processing time is 30 minutes or more, the water contact angle is 170° or more.

FIG. 12 shows that if the process of the present disclosure is performed on a superhydrophobic surface formed on a large-area surface of 5 cm×15 cm in accordance with the present example, it is possible to easily form the large-area superhydrophobic surface.

The illustrative embodiments and example have been provided for illustration of the present disclosure, but the present disclosure is not limited thereto. It is clear to those skilled in the art that the illustrative embodiments and example can be changed and modified in various ways within the scope of the present disclosure.

1. An organic/inorganic hybrid hierarchical structure, comprising:
a polymer electrolyte layer which is formed on a substrate and has a rough surface; and
an inorganic nano structure which is formed at the rough surface of the polymer electrolyte layer.

2. The organic/inorganic hybrid hierarchical structure of claim 1,
wherein a surface energy increasing/decreasing material is further included on the inorganic nano structure to provide a superhydrophobic or superhydrophilic property.

3. The organic/inorganic hybrid hierarchical structure of claim 1,
wherein a shape of the inorganic nano structure is selected from the group consisting of a nanoparticle, a nanoplate, a nanorod, a nanoneedle, a nanotube, and a nanowall.

4. The organic/inorganic hybrid hierarchical structure of claim 1,
wherein the inorganic nano structure is protruded from the rough surface of the polymer electrolyte layer.

5. The organic/inorganic hybrid hierarchical structure of claim 1,
wherein the inorganic nano structure has nanopores.

6. The organic/inorganic hybrid hierarchical structure of claim 1,
wherein a surface roughness of the polymer electrolyte layer has a size in micrometric units.

7. The organic/inorganic hybrid hierarchical structure of claim 1,
wherein the inorganic nano structure includes a metal or a semiconductor.

8. The organic/inorganic hybrid hierarchical structure of claim 1,
wherein the polymer electrolyte layer having the rough surface includes a cationic polymer electrolyte layer and an anionic polymer electrolyte layer formed alternately.

9. A method for forming a superhydrophobic or superhydrophilic surface, comprising:
forming a polymer electrolyte layer on a substrate;
forming an inorganic nanoparticle at the polymer electrolyte layer to form a polymer electrolyte/inorganic nanoparticle composite layer having a surface roughness; and
removing the polymer electrolyte layer from the composite layer and forming an inorganic nano structure along the surface roughness to form an organic/inorganic hybrid hierarchical structure.

10. The method of claim 9, further comprising:
forming a surface energy increasing/decreasing material layer on the hierarchical structure for making the superhydrophobic or superhydrophilic property.

11. The method of claim 10,
wherein the surface energy increasing/decreasing material layer includes a self-assembly monomolecular layer formed by using a material containing a fluorine group and a hydrophilic or hydrophobic end group.

12. The method of claim 9,
wherein the polymer electrolyte layer includes an ionic functional group at its polymer chain, and the inorganic nanoparticle is formed by using an ionic inorganic precursor.

13. The method of claim 12,
wherein in the forming of a polymer electrolyte/inorganic nanoparticle composite layer having a surface roughness,
forming of the inorganic nanoparticle includes
implanting an inorganic cation into the polymer electrolyte layer by means of diffusion through an ion-exchange reaction between an ionic functional group contained in the polymer electrolyte and the inorganic cation contained in the ionic inorganic precursor by implanting the ionic inorganic precursor from the surface of the polymer electrolyte layer, and forming the inorganic nanoparticle by implanting a reducing agent from the surface of the polymer electrolyte layer to reduce the inorganic cation implanted into the polymer electrolyte layer.

14. The method of claim 9,
wherein the inorganic nanoparticle is formed within the polymer electrolyte layer at a predetermined depth from the surface of the polymer electrolyte layer to form the composite layer, and as an amount of the formed inorganic nanoparticle increases, the surface roughness of the composite layer increases.

15. The method of claim 9,
wherein an amount and thickness of the inorganic nanoparticle are adjusted by performing the process for forming the inorganic nanoparticle once or more to adjust the surface roughness of the composite layer.

16. The method of claim 9,
wherein the polymer electrolyte layer includes a cationic polymer electrolyte layer and an anionic polymer electrolyte layer formed alternately.

17. The method of claim 9,
wherein the forming of the organic/inorganic hybrid hierarchical structure includes selectively removing the polymer electrolyte by using the inorganic nanoparticle contained in the polymer electrolyte/inorganic nanoparticle composite layer having the surface roughness as a mask to form the inorganic nano structure along the surface roughness.

18. The method of claim 17,
wherein the removing the polymer electrolyte is performed by reactive ion etching (RIE) or plasma ashing.

19. The method of claim 9,
wherein the surface roughness is formed in micrometers.

20. A superhydrophobic or superhydrophilic surface formed by using an organic/inorganic hybrid hierarchical structure by the method of claim 9.
